(19) United States
(12) Patent Application Publication
(10) Pub. No.: US 2025/0357682 A1
(43) Pub. Date: Nov. 20, 2025

(54) ELECTRICAL CONTACT SPRING

(71) Applicant: Yazaki Corporation, Tokyo (JP)

(72) Inventor: Jundai GOTO, Shizuoka (JP)

(73) Assignee: Yazaki Corporation, Tokyo (JP)

(21) Appl. No.: 19/198,298

(22) Filed: May 5, 2025

(30) Foreign Application Priority Data
May 15, 2024 (JP) 2024-079277

(51) Int. Cl. H01R 4/48; H01R 4/58

(52) U.S. Cl. CPC H01R 4/48; H01R 4/58

(57) ABSTRACT

An electrical contact spring includes a metallic material, wherein S/Y is 1.2 or more and 2.5 or less when a vicinity of a boundary between an elastic region and a plastic region in a true stress−true strain curve of the metallic material is approximated using the Voce equation expressed in equation σ=S−(S−Y)exp^{-cε}, where S is a maximum value of true stress σ of the metallic material, Y is elastic limit stress of the metallic material, and c is a constant related to logarithmic plastic strain ε of the metallic material.

### CROSS-REFERENCE TO RELATED APPLICATIONS

The present application is based on, and claims priority from the prior Japanese Patent Application No. 2024-079277, filed on May 15, 2024, the entire contents of which are incorporated herein by reference.

### TECHNICAL FIELD

The present disclosure relates to an electrical contact spring.

### BACKGROUND

When high voltage wires used as vehicle electric wiring are connected to mating connector bodies (for example, motors, inverters, and high voltage batteries), it is necessary to have a structure where electrical contact states of connection parts can be maintained well even with vibration and heat. Thus, high voltage terminals having a spring structure and keeping contact by reaction force of the spring are used for the connection parts. However, when such high voltage terminals are used in a high-temperature environment, the reaction force of the spring may decrease due to a stress relaxation phenomenon. JP 2016-20543 A discloses a copper alloy material that controls the reduction of the reaction force of the spring due to the stress relaxation phenomenon.

JP 2016-20543 A discloses a copper alloy material for electrical and electronic components having high strength, high conductivity, and excellent resistance to stress relaxation. Specifically disclosed is a copper alloy material for electrical and electronic components which: contains Cr in an amount of 0.10% to 0.50% by mass, Ti in an amount of 0.005% to 0.50% by mass, and Si in an amount of 0.005% to 0.20% by mass; is regulated to 150 ppm or less of O and 5 ppm or less of H; contains Cu and unavoidable impurities as a remainder; has a metal structure with an average grain size of 15 μm or less in a rolling direction, and an average grain size of 10 μm or less in a plate thickness direction, according to cross-sectional SEM observation; and has 30 or fewer compounds containing Cr, Si, or other elements per 500 μm² and having a grain size of 5 μm or less.

### SUMMARY OF THE INVENTION

Conventionally, for metallic materials for electrical contacts, improving spring reaction force and stress relaxation resistance has been targeted by adjusting alloy components and internal structure as described in JP 2016-20543 A. However, adjustment of alloy components and internal structure needs to be optimized from an innumerable amount of options, and many experiments are required. Therefore, there is a need for a simple method for achieving both spring reaction force and stress relaxation resistance.

This disclosure has been made in view of the issue in the prior art. The purpose of the present disclosure is to provide an electrical contact spring capable of achieving both spring reaction force and stress relaxation resistance using a simple method.

An electrical contact spring according to an embodiment of the present disclosure includes a metallic material, wherein S/Y is 1.2 or more and 2.5 or less when a vicinity of a boundary between an elastic region and a plastic region in a true stress−true strain curve of the metallic material is approximated using the Voce equation expressed in equation 1

$$σ = S - ( S - Y ) {exp}^{- c ε} \qquad [ Equation 1 ]$$

where S is a maximum value of true stress σ of the metallic material, Y is elastic limit stress of the metallic material, and c is a constant related to logarithmic plastic strain ε of the metallic material.

According to the present disclosure, it is possible to provide an electrical contact spring capable of achieving improved spring reaction force and stress relaxation resistance using a simple method.

### BRIEF DESCRIPTION OF DRAWINGS

FIG. 1 is a perspective view illustrating an example of an electrical contact spring according to an embodiment.

FIG. 2 is a graph illustrating a true stress σ−true strain ε curve of beryllium copper, and an approximate curve according to Voce law, and an approximate curve according to Hooke's law.

FIG. 3 is a graph illustrating a state where a true stress−true strain curve in a range where the maximum stress is from 0% to 30%, is linearly approximated relative to measured values of the true stress−true strain curve of a metallic material, and then a tangent A of an apparent elastic modulus is drawn, in a case of obtaining an elastic limit stress Y.

FIG. 4 is a graph illustrating a result of determining the relationship between the true strain, and the amount of deviation between the tangent A and the true stress−true strain curve, from FIG. 3.

FIG. 5 is a graph illustrating measured values of the true stress−true strain curve of beryllium copper.

FIG. 6A is a diagram illustrating a result of structural analysis.

FIG. 6B is a graph illustrating an example of the relationship between push-in depth of an indent, and a spring load of a long plate, based on structural analysis.

FIG. 7 is a graph illustrating a result of determining, using structural analysis, an area where a plastic strain does not occur when a longitudinal center part of a convex part of the long plate is pressed.

FIG. 8 is a graph illustrating true stress−true strain curves of several kinds of metallic materials, and results of the structural analysis with S/Y=1.03 and S/Y=3.8.

FIG. 9 is a graph illustrating true stress−true strain curves of several kinds of metallic materials, a spring load F, and a volume percentage V which is an index of a stress relaxation resistance V, when the S/Y ratio is from 1 to 3.4.

FIG. 10 is a diagram explaining how to determine a creep speed.

FIG. 11 is a table illustrating the relationship between an S value and a Y value of various metallic materials.

FIG. 12 is a graph illustrating a principal component plot where principal component scores obtained through principal component analysis are plotted.

FIG. 13A is a graph illustrating principal component scores of values obtained by adding the spring load F and the volume percentage V.

FIG. 13B is a graph illustrating principal component scores of H/t ratios corresponding to additions of the spring load F and the volume percentage V in FIG. 13A.

### DETAILED DESCRIPTION OF THE INVENTION

Referring to the drawings, a description is given below of an electrical contact spring according to the present embodiment. Note that dimensional ratios in the drawings are exaggerated for convenience of the description and are sometimes different from actual ratios.

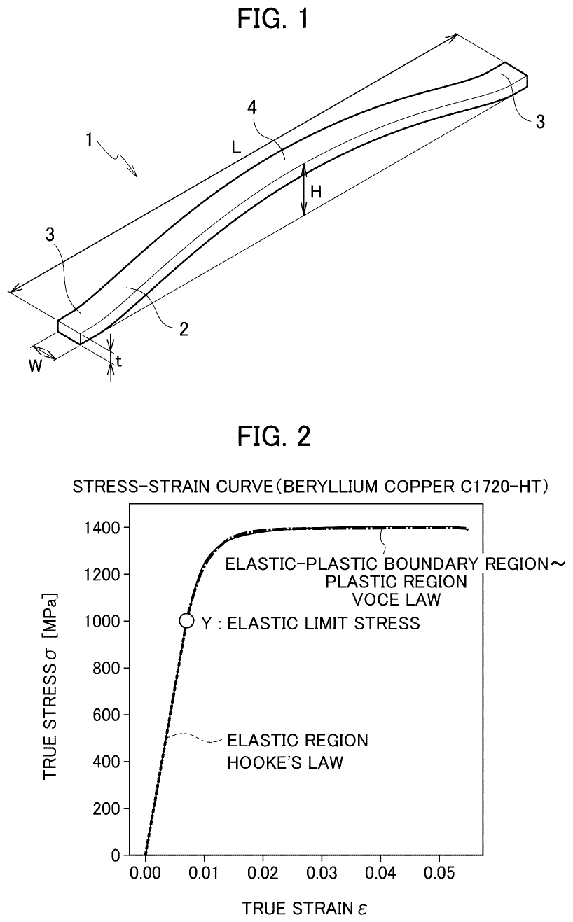

As illustrated in FIG. 1, an electrical contact spring 1 according to the present embodiment can be a plate spring including a long plate 2. In the electrical contact spring 1, the long plate 2 includes a convex part 4 that is more convex than both end parts 3 of the long plate 2, at a center part of the long plate 2 in a longitudinal direction. Thus, when the electrical contact spring 1 is viewed from a side, the long plate 2 has a shape curved like a bow, and the convex part 4 has a substantially arc shape.

For example, the electrical contact spring 1 contacts a mating terminal inserted into a high voltage terminal, and is used as a part of a spring component provided inside the high voltage terminal. In the spring component, the electrical contact spring 1 can be used as a doubly supported spring.

The electrical contact spring 1 is a spring made from a metallic material, wherein S/Y is 1.2 or more and 2.5 or less, when a vicinity of a boundary between an elastic region and a plastic region in a true stress−true strain curve of the metallic material is approximated using the Voce equation expressed in equation 2 below.

$$σ = S - ( S - Y ) {exp}^{- c ε} \qquad [ Equation 2 ]$$

Note that in equation 2, S is the maximum value of a true stress σ of the metallic material, Y is an elastic limit stress, and c is a constant related to a logarithmic plastic strain ε.

To explain in detail, the true stress−true strain curve of the metallic material can be obtained by measuring elastic-plastic deformation properties of the metallic material using a uniaxial tensile test method. Specifically, the elastic-plastic deformation properties of the metallic material are measured according to Japanese Industrial Standards JIS Z2201 (Test pieces for tensile test for metallic materials) and JIS Z2241 (Metallic materials-Tensile testing-Method of test at room temperature). Consequently, measured values of the true stress−true strain curve of the metallic material used for the electrical contact spring 1 can be obtained. Note that the true strain is also called logarithmic plastic strain. FIG. 2 illustrates measured values of a true stress σ−true strain ε curve for beryllium copper.

Next, an approximate calculation using the Voce law is performed on the measured values obtained for the true stress σ−true strain ε curve. For the approximate calculation, for example, an optimize function, curve_fit, from a numerical analysis library, scipy, of a programming language Python, can be used. By using such an approximate calculation, an approximate curve based on the Voce law, as illustrated in FIG. 2, can be obtained. From this approximate curve, the maximum value S of the true stress σ of the metallic material, and the constant c related to the logarithmic plastic strain ε of the metallic material can be obtained.

The elastic limit stress Y in equation 2 can be obtained as follows. First, as illustrated in FIG. 3, a true stress−true strain curve in a range where the maximum stress is from 0% to 30%, is linearly approximated relative to measured values of the true stress−true strain curve of the metallic material, and then the tangent A of the apparent elastic modulus is drawn. Next, the amount of deviation between the tangent A and the true stress−true strain curve is obtained in terms of the true strain. Then, the true stress where the obtained amount of deviation of the true strain is 0.02% is used as the elastic limit stress Y.

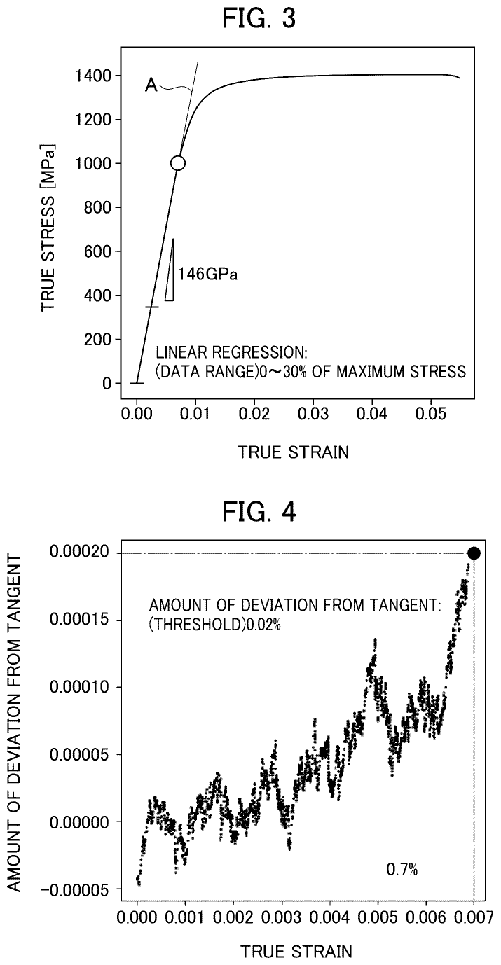

Specifically, a true stress−true strain curve in a range where the maximum stress is from 0% to 30%, is linearly approximated relative to measured values of the true stress−true strain curve of beryllium copper, illustrated in FIG. 3, and then the tangent A of the apparent elastic modulus is drawn. Next, as illustrated in FIG. 4, after graphing the relationship of the amount of deviation between the tangent A and the true stress−true strain curve, a true strain where the amount of deviation between the tangent A and the true stress−true strain curve is 0.02% is obtained. From FIG. 4, the true strain is 0.7% where the amount of deviation between the tangent A and the true stress−true strain curve is 0.02%.

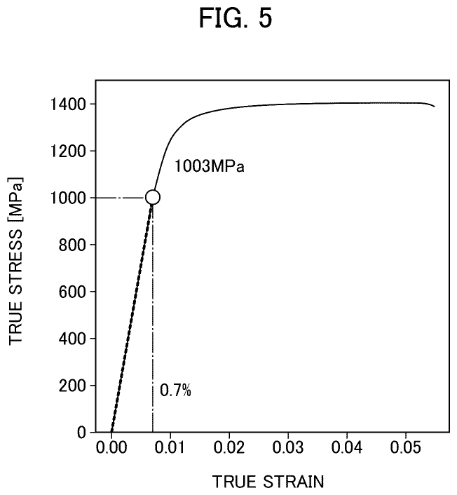

FIG. 5 illustrates measured values of the true stress−true strain curve of beryllium copper. From FIG. 5, a true stress where the true strain is 0.7% (0.007) is 1,003 MPa. This value, 1,003 MPa, is used as the elastic limit stress Y.

Here, a region where the true stress is less than or equal to the elastic limit stress Y is an elastic region where the metallic material deforms elastically, and can be approximated using Hooke's law in equation 3.

$$σ = k ε \qquad [ Equation 3 ]$$

In equation 3, σ is true stress, k is Young's modulus, and ε is true strain.

In contrast, a region where the true stress exceeds the elastic limit stress Y is a plastic region from the elastic-plastic boundary region of the metallic material, and can be approximated using the Voce law illustrated in equation 2. Note that a stress−strain curve model, such as the Voce law, is generally used for a plastic region after offset proof stress (0.2% proof stress, etc.), but in the present disclosure, it is used to express the behavior of the elastic-plastic boundary.

Then, structural analysis is performed based on the S and Y values of the metallic material thus obtained. The structural analysis can be performed using AFDEX (forging analysis software) version 21R03, manufactured by JSOL CORPORATION. Note that the shape of the long plate 2 for structural analysis is as illustrated in FIG. 1. Specifically, the long plate 2, obtained by curving a rectangular parallelepiped plate into a bow shape, is used, and the length L in the longitudinal direction is set to 14.02 mm, the height H from the lower surface of the both end parts 3 of the long plate 2 to the upper surface of the convex part 4 is set to 1.0 mm, the width W is set to 0.65 mm, and the plate thickness t is set to 0.30 mm. Note that the length L, the height H, the width W, and the plate thickness t of the long plate 2 are values obtained by optimizing the shape of the electrical contact spring by performing structural analysis using the above-described software.

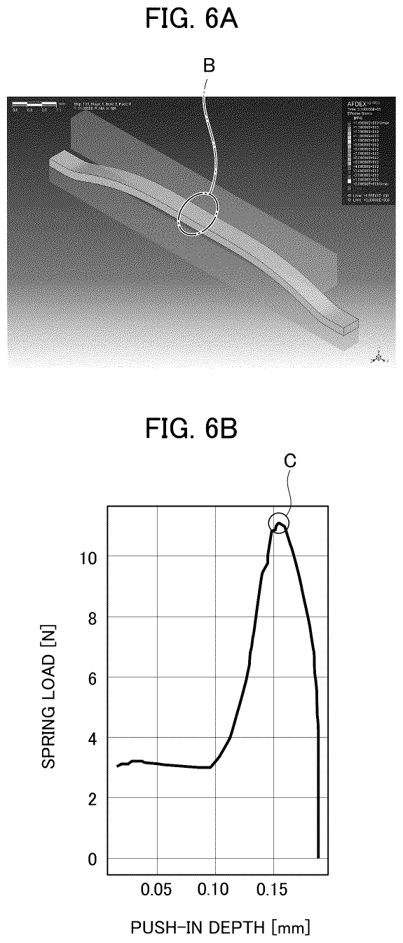

Through the structural analysis, a spring load F and a stress relaxation resistance V, which are component performances of the electrical contact spring, are obtained. As the spring load F, as illustrated in FIG. 6A, when a longitudinal center B of the convex part 4 of the long plate 2 is pressed with an indenter, a load applied to the indenter is calculated. FIG. 6B illustrates an example of a simulation result of a push-in depth (mm) of the indenter, and a spring load (N) of the long plate 2. As illustrated in FIG. 6B, the spring load F is a value of a point C where the spring load is maximum relative to the push-in depth of the indent.

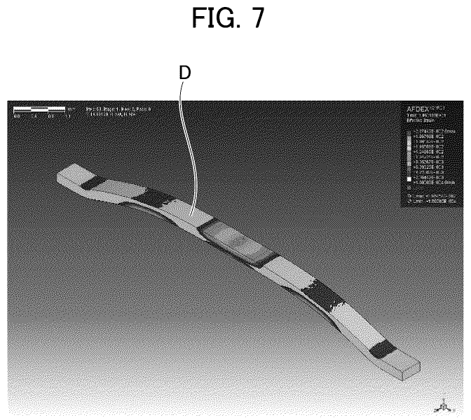

As the stress relaxation resistance V, as illustrated in FIG. 7, when the longitudinal center B of the convex part 4 of the long plate 2 is pressed, an area where no plastic strain occurs is determined, and the volume percentage of an area D where no plastic strain occurs is calculated. Note that the volume percentage of the area D, where no plastic strain occurs, is a percentage of the volume of the area D, where no plastic strain occurs, relative to the total volume of the long plate 2. The plastic strain causes the stress relaxation of the spring, and the larger the volume percentage of the area D, where no plastic strain occurs, the less stress relaxation occurs, and the better the stress relaxation resistance V.

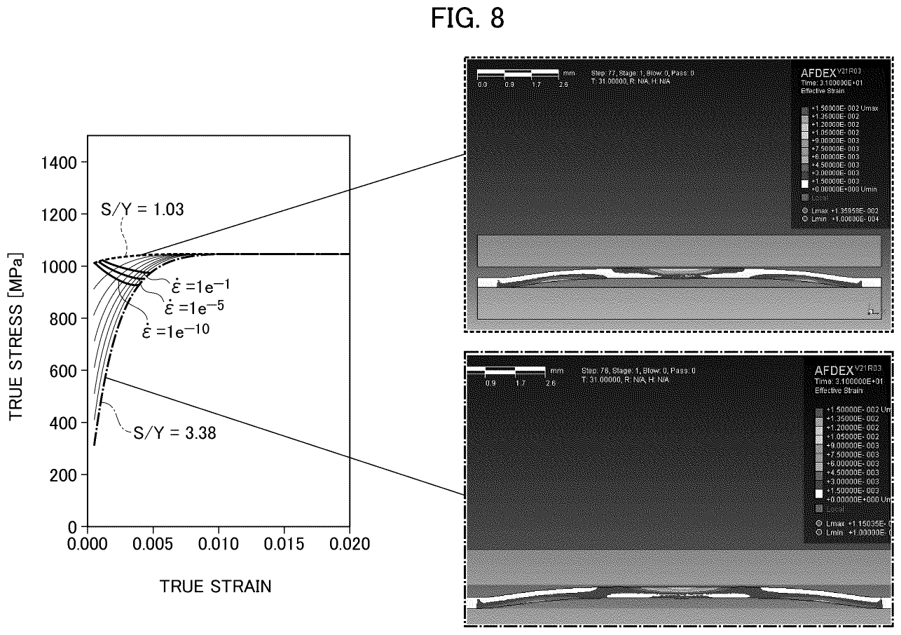

Then, using multiple kinds of metals as the metallic material of the electrical contact spring 1, true stress−true strain curves are measured, and S and Y values are further calculated. From the calculated S and Y values, the spring load F and the stress relaxation resistance V are obtained through structural analysis. FIG. 8 illustrates thus obtained true stress−true strain curves of the multiple kinds of metallic materials, and the results of structural analysis with S/Y=1.03 and S/Y=3.8. It is evident from FIG. 8 that when S/Y is low, such as S/Y=1.03, and when the longitudinal center B of the convex part 4 of the long plate 2 is pressed, deformation of the long plate 2 does not propagate to the entirety of the long plate 2, and thus a large local plastic strain is concentrated. Therefore, when S/Y is low, the stress relaxation resistance V decreases. In contrast, it is evident that when S/Y is high, such as S/Y=3.8, plastic deformation spreads as the longitudinal center B of the convex part 4 of the long plate 2 is pressed, and a small plastic strain is uniformly distributed over a wide area. Therefore, if a region with a creep speed of 1×10⁻⁵/s or less, which will be described below, is defined as an unstrained region, the volume percentage of the region D, where no plastic strain occurs, is higher at a high S/Y ratio, and the stress relaxation resistance V is expected to be improved.

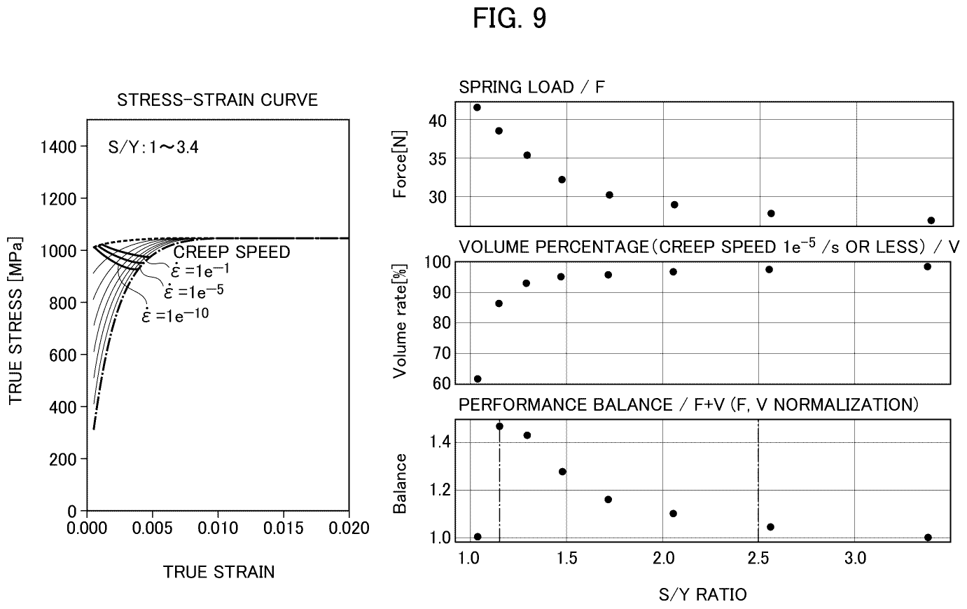

FIG. 9 illustrates the true stress−true strain curves of the multiple kinds of metallic materials, obtained as described above, the spring load F and the volume percentage V which is an index of the stress relaxation resistance V, when the S/Y ratio is from 1 to 3.4. Note that the volume percentage V is a value when a creep speed is 1×10⁻⁵/s (1e⁻⁵/s) or less, which will be described below. As illustrated in FIG. 9, as the S/Y ratio increases, the spring load F gradually decreases while the volume percentage V gradually increases.

In FIG. 9, normalization is performed where the maximum value of the spring load F is 1, and the minimum value of the spring load F is 0. Similarly, normalization is performed where the maximum value of the volume percentage V is 1, and the minimum value of the volume percentage V is 0. Then, performance balance is obtained by adding the normalized spring load F and volume percentage V. Consequently, as illustrated in FIG. 9, when S/Y is 1.2 or more and 2.5 or less, the balance between the spring load F and the volume percentage, which is an index of the stress relaxation resistance V, is excellent, and it is possible to achieve both the excellent spring load and the excellent stress relaxation resistance.

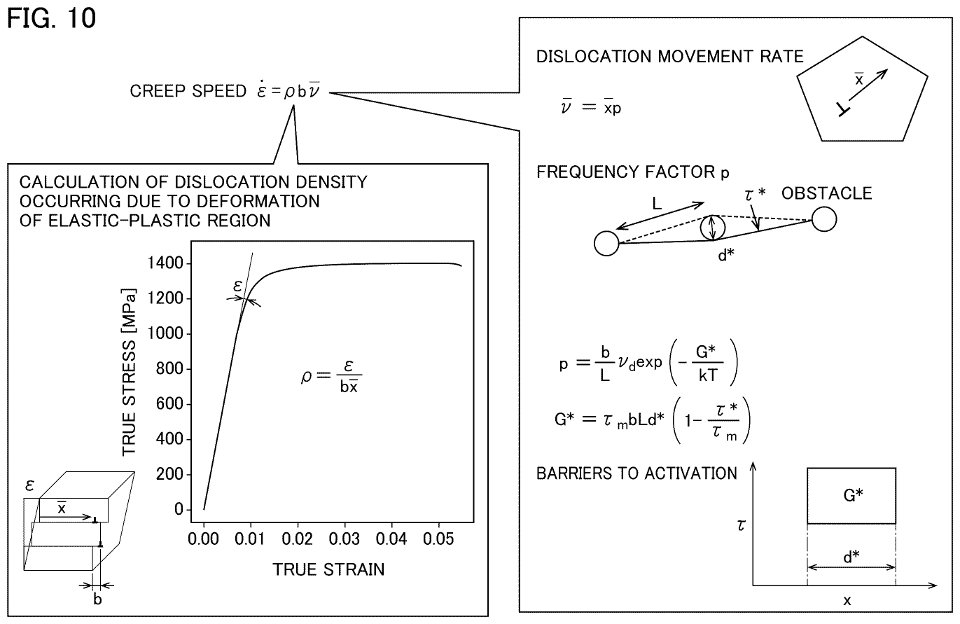

Note that in this specification, the region where the creep speed at the volume percentage V is 1×10⁻⁵/s or less is defined as the unstrained region. The creep speed can be obtained as follows. As illustrated in FIG. 10, the creep speed is defined as equation 4 below, based on the relation between dislocation motion and macroscopic crystal deformation, assuming that the creep phenomenon proceeds only by dislocation motion in crystal grains.

$$\dot{ε} = ρ b \overline{v} \qquad [ Equation 4 ]$$

where ε dot [s⁻¹], ρ [m⁻²], b [m], and ν bar [m/s] are strain rate, dislocation density, Burgers vector (a constant, 2.56e⁻¹⁰ m in the case of copper), and average motion velocity of dislocation, respectively.

The dislocation density ρ [m⁻²], and the average motion velocity of dislocation ν [m/s] in equation 4 can be calculated as follows.

The dislocation density ρ [m⁻²] in equation 4 can be calculated from equation 5 using the relation between dislocation motion and macroscopic crystal deformation as in equation 4.

$$ρ = \frac{ε}{b \overline{x}} \qquad [ Equation 5 ]$$

where ε, b, and x bar are logarithmic true strain, Burgers vector (a constant), and mean free path (moving distance) of dislocation, respectively.

The value x varies depending on each material, but in this specification, assuming a condition where dislocation exists at high density (cold-worked material), which is common in copper alloys, the mean free path (moving distance) of dislocation is 1e⁻⁸ m. Using this equation, p at any logarithmic plastic strain ε on the true stress σ-logarithmic plastic strain ε curve was calculated.

The average motion velocity ν [m/s] of dislocation in equation 4 is expressed in terms of the average moving distance of dislocation, and an occurrence frequency p as follows.

$$\overline{v} = \overline{x} p \qquad [ Equation 6 ]$$

where temperature and load stress, which are conditions for creep, are related to the occurrence frequency p. The occurrence frequency p is expressed in equation 7 below.

$$p = \frac{b}{L} {v}_{d} exp ( - \frac{{G}^{*}}{kT} ) \qquad [ Equation 7 ]$$

where L, ν_{d}, k, T, and G* are the distance between obstacles in dislocation motion (precipitates or solid solution atoms), a thermal frequency of copper (1e¹³), the Boltzmann constant, temperature, and a thermal activation energy of dislocation motion, respectively. Here, equation 8 is used for the thermal activation energy G* of dislocation motion.

$${G}^{*} = {τ}_{m} bLd * ( 1 - \frac{{τ}^{*}}{{τ}_{m}} ) \qquad [ Equation 8 ]$$

where τₘ, d*, and τ* are critical resolved shear stress, obstacle size, and load stress, respectively.

Equations 6 to 8 can be used to calculate the average motion velocity ν of dislocation at any true stress σ on the true stress σ-logarithmic plastic strain ε curve.

As described above, the electrical contact spring 1 according to the present embodiment is made from a metallic material, wherein S/Y is from 1.2 to 2.5 when the vicinity of the boundary between the elastic region and the plastic region in the true stress−true strain curve of the metallic material is approximated using the Voce equation expressed in equation 2. When S/Y is from 1.2 to 2.5, the balance between the spring load F, and the volume percentage, which is an index of the stress relaxation resistance V, is excellent, and thus the electrical contact spring 1 can be obtained achieving both the excellent spring load and the excellent stress relaxation resistance.

In the metallic material for the electrical contact spring 1, the following method can be used to control the S/Y ratio to 1.2 or more and 2.5 or less. It is generally known that a mechanical response of a metallic material changes greatly depending on microstructure, which is a microscopic structure inside the material. The S/Y ratio specified in the present disclosure quantifies slight plastic deformation during transition from the elastic region to the plastic region in the mechanical response. Therefore, the S/Y ratio is controlled by generation of dislocations, and structural factors related to their motion. In the case of copper alloys, main structural factors related to properties include crystal defects (dislocation and grain boundaries), precipitated phases, and solid solution atoms. By controlling these factors, a material having a predetermined S/Y ratio can be obtained.

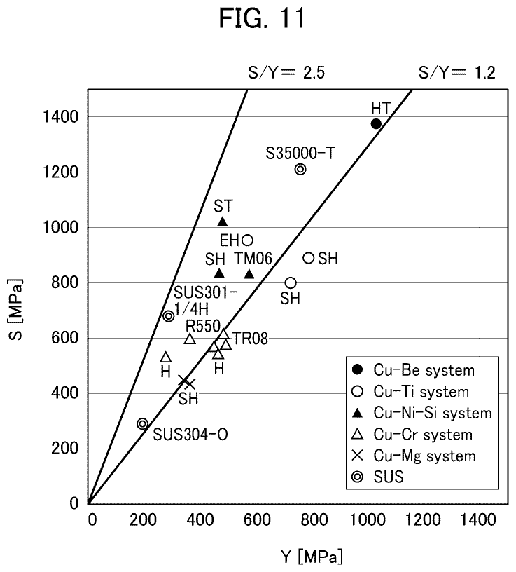

FIG. 11 illustrates the relationship between the S value and the Y value of various metallic materials. As illustrated in FIG. 11, metallic materials for the electrical contact spring 1, satisfying S/Y=1.2 to 2.5, include a copper-beryllium-based alloy, a copper-titanium-based alloy, a copper-nickel-silicon-based alloy, a copper-chromium-based alloy, a copper-magnesium-based alloy, and austenite-based stainless steel (SUS). An example of the copper-beryllium-based alloy is C1720-HT. An example of the copper-titanium-based alloy is C19900-EH. Examples of the copper-nickel-silicon-based alloy include C70350-TM06, C70252-SH, and C64790-ST. Examples of the copper-chromium-based alloy include C18070-H, C18070-R550, and C18080-TR08. An example of the copper-magnesium-based alloy is C10850-SH. Examples of the austenite-based stainless steel (SUS) include SUS301 and SUS304. However, the metallic materials are not limited to these alloys, and a material having a predetermined S/Y ratio can be obtained by controlling crystal defects (dislocation and grain boundaries), precipitated phases, and solid solution atoms, as described above.

As described above, the electrical contact spring 1 according to the present embodiment includes the long plate 2, which can have a shape with the convex part 4, which is more convex than the both end parts 3 of the long plate 2, at the center part of the long plate 2 in the longitudinal direction. Here, the height H (H/t) from the both end parts 3 of the long plate 2 to the convex part 4 relative to the thickness t of the long plate 2 is preferably 1.8 or more and 3.7 or less. Note that the height H is from the lower surface of the both end parts 3 of the long plate 2 to the upper surface of the convex part 4. When the height H is within this range, it is possible to achieve both excellent spring load and excellent stress relaxation resistance.

The reason why the height H (H/t) from the both end parts 3 of the long plate 2 to the convex part 4 relative to the thickness t of the long plate 2 is preferably 1.8 or more and 3.7 or less, is determined by performing principal component analysis. Principal component analysis (PCA) is a typical method of dimensionality reduction. It is a method of performing dimensionality reduction by projecting data onto a hyperplane (a plane defined by n−1 dimensions in an n-dimensional space) in a multidimensional data space. Data projected onto the coordinate axes constituting the hyperplane is called a principal component. In PCA, correlation between data can be analyzed from factor loadings, which are correlation coefficient matrices between the principal component and the original data.

In this specification, PCA is used to extract shape features, which contribute to the balance of the performance (spring load and stress relaxation resistance), of the electrical contact spring 1. Specifically, shape factors, L/t ratio, L/W ratio, L/H ratio, H/t ratio, H/W ratio, and W/t ratio of length L, height H, width W, and plate thickness t; and material factors, S/Y ratio, spring load F, and stress relaxation resistance index V, are set as a data set of 39 rows and 9 columns. Principal component analysis is performed using the data set. Table 1 lists specific values of the data set of L/t ratio, L/W ratio, L/H ratio, H/t ratio, H/W ratio, W/t ratio, S/Y ratio, spring load F, and stress relaxation resistance index V. Note that in Table 1, “B” is an index satisfying S/Y=1.2 to 2.5, and “A” is an index satisfying S/Y=1.2 to 2.5, and H/t=1.8 to 3.7.

TABLE 1

| | L | H | W | t | L/t | H/t | W/t | L/W | H/W | L/H | S | Y | S/Y | F | V | |
|---|---|---|---|---|---|---|---|---|---|---|---|---|---|---|---|---|
| index | mm | mm | mm | mm | — | — | — | — | — | — | MPa | MPa | — | N | % | |
| 0 | 12.7 | 0.8 | 0.8 | 0.3 | 40.2 | 2.5 | 2.6 | 15.5 | 1 | 16 | 1235 | 1201 | 1.0 | 49.6 | 99 | — |
| 1 | 10.1 | 0.8 | 0.9 | 0.3 | 31.4 | 2.4 | 2.7 | 11.6 | 0.9 | 13 | 1249 | 1125 | 1.1 | 63.6 | 71 | — |
| 2 | 15.5 | 1 | 0.9 | 0.4 | 42.4 | 2.6 | 2.3 | 18.1 | 1.1 | 16.2 | 964 | 570 | 1.7 | 34.3 | 95 | A |
| 3 | 12.9 | 0.9 | 0.7 | 0.4 | 30.6 | 2 | 1.7 | 18.3 | 1.2 | 15 | 1334 | 963 | 1.4 | 51.2 | 96 | A |
| 4 | 8.5 | 1 | 0.7 | 0.4 | 22.1 | 2.7 | 1.9 | 11.4 | 1.4 | 8.2 | 1192 | 708 | 1.7 | 94.8 | 48 | A |
| 5 | 8.3 | 0.9 | 1 | 0.4 | 23.5 | 2.6 | 2.8 | 8.5 | 0.9 | 9.1 | 921 | 77 | 11.9 | 79.6 | 27 | — |
| 6 | 10.7 | 1.4 | 1 | 0.3 | 41.3 | 5.2 | 3.7 | 11.2 | 1.4 | 7.9 | 1121 | 592 | 1.9 | 66 | 59 | B |
| 7 | 11.1 | 1.3 | 0.8 | 0.3 | 33.8 | 3.9 | 2.6 | 13.2 | 1.5 | 8.6 | 893 | 206 | 4.3 | 54.6 | 59 | — |
| 8 | 11.7 | 1 | 0.9 | 0.3 | 39.4 | 3.3 | 3 | 13.1 | 1.1 | 12 | 1106 | 1050 | 1.1 | 56.3 | 64 | — |
| 9 | 14.3 | 1.3 | 0.5 | 0.5 | 29.5 | 2.7 | 1.1 | 26.3 | 2.4 | 10.8 | 1363 | 924 | 1.5 | 72.5 | 88 | A |
| 10 | 11.3 | 1.4 | 0.6 | 0.3 | 44.6 | 5.6 | 2.4 | 18.6 | 2.3 | 7.9 | 1306 | 980 | 1.3 | 43.5 | 66 | B |
| 11 | 11.5 | 0.9 | 0.8 | 0.4 | 27.7 | 2.3 | 1.9 | 14.7 | 1.2 | 12.2 | 1135 | 921 | 1.2 | 67.8 | 68 | A |
| 12 | 11.9 | 1.1 | 0.7 | 0.4 | 27.4 | 2.6 | 1.7 | 16.6 | 1.6 | 10.6 | 1021 | 672 | 1.5 | 58.5 | 61 | A |
| 13 | 15.7 | 1.3 | 0.8 | 0.5 | 32 | 2.6 | 1.6 | 19.8 | 1.6 | 12.3 | 1263 | 1004 | 1.3 | 85.9 | 90 | A |
| 14 | 14.9 | 1.4 | 1 | 0.4 | 38.1 | 3.5 | 2.5 | 15 | 1.4 | 10.9 | 836 | 689 | 1.2 | 63.6 | 76 | A |
| 15 | 10.9 | 0.9 | 0.7 | 0.3 | 32 | 2.6 | 1.9 | 16.6 | 1.4 | 12.2 | 1178 | 401 | 2.9 | 37.3 | 56 | — |
| 16 | 10.3 | 1.4 | 0.8 | 0.3 | 34 | 4.6 | 2.7 | 12.8 | 1.7 | 7.4 | 1206 | 700 | 1.7 | 78.9 | 53 | B |
| 17 | 15.9 | 1.2 | 0.8 | 0.5 | 35.1 | 2.6 | 1.7 | 21 | 1.6 | 13.5 | 821 | 810 | 1.0 | 48.8 | 82 | — |
| 18 | 8.1 | 1.1 | 0.6 | 0.5 | 16.9 | 2.2 | 1.2 | 14.6 | 1.9 | 7.5 | 1163 | 860 | 1.4 | 90.9 | 78 | A |
| 19 | 15.3 | 1.2 | 0.6 | 0.4 | 42.6 | 3.5 | 1.6 | 26.9 | 2.2 | 12.3 | 950 | 151 | 6.3 | 26.2 | 66 | — |
| 20 | 13.5 | 1.1 | 0.7 | 0.4 | 34 | 2.9 | 1.7 | 19.8 | 1.7 | 11.8 | 1277 | 569 | 2.2 | 57.7 | 62 | A |
| 21 | 9.3 | 0.9 | 0.8 | 0.3 | 33.4 | 3.3 | 3 | 11.2 | 1.1 | 10 | 1007 | 365 | 2.8 | 47.4 | 78 | — |
| 22 | 13.1 | 1.3 | 0.5 | 0.3 | 42.3 | 4.3 | 1.7 | 24.7 | 2.5 | 9.8 | 1149 | 260 | 4.4 | 36.7 | 57 | — |
| 23 | 10.5 | 1 | 0.9 | 0.3 | 31.4 | 3.1 | 2.7 | 11.6 | 1.1 | 10.2 | 1292 | 1123 | 1.2 | 96.6 | 74 | A |
| 24 | 12.3 | 1 | 0.5 | 0.4 | 30 | 2.4 | 1.3 | 23.7 | 1.9 | 12.4 | 1049 | 431 | 2.4 | 36.1 | 61 | A |
| 25 | 8.7 | 1.1 | 0.9 | 0.3 | 30.6 | 3.9 | 3.3 | 9.2 | 1.2 | 7.9 | 1078 | 887 | 1.2 | 81.6 | 75 | B |
| 26 | 15.1 | 0.8 | 0.7 | 0.4 | 34.3 | 1.8 | 1.7 | 20.6 | 1.1 | 18.6 | 1320 | 859 | 1.5 | 44 | 76 | A |
| 27 | 12.1 | 0.8 | 1 | 0.3 | 45.6 | 3.1 | 3.6 | 12.5 | 0.9 | 14.6 | 1220 | 557 | 2.2 | 42.7 | 78 | A |
| 28 | 12.5 | 1.1 | 0.8 | 0.4 | 28 | 2.4 | 1.7 | 16.3 | 1.4 | 11.8 | 1035 | 484 | 2.1 | 64.2 | 81 | A |
| 29 | 9.7 | 1.2 | 0.9 | 0.5 | 20.6 | 2.6 | 1.9 | 10.6 | 1.3 | 7.9 | 992 | 576 | 1.7 | 115 | 42 | A |
| 30 | 14.1 | 1.3 | 0.6 | 0.4 | 32.9 | 2.9 | 1.4 | 22.8 | 2 | 11.2 | 1092 | 518 | 2.1 | 42.1 | 90 | A |
| 31 | 13.9 | 1.2 | 0.7 | 0.5 | 30.3 | 2.6 | 1.5 | 20 | 1.7 | 11.7 | 878 | 800 | 1.1 | 53.2 | 96 | — |
| 32 | 9.5 | 0.8 | 0.9 | 0.4 | 25.1 | 2.2 | 2.5 | 10.2 | 0.9 | 11.3 | 1349 | 482 | 2.8 | 91 | 41 | — |
| 33 | 9.1 | 0.9 | 0.6 | 0.3 | 31.3 | 3 | 2 | 15.7 | 1.5 | 10.4 | 850 | 119 | 7.2 | 29.3 | 39 | — |
| 34 | 9.9 | 1.4 | 0.9 | 0.5 | 19.9 | 2.8 | 1.8 | 11.2 | 1.6 | 7 | 907 | 153 | 5.9 | 121 | 36 | — |
| 35 | 14.5 | 1 | 0.6 | 0.4 | 39 | 2.7 | 1.6 | 24.4 | 1.7 | 14.4 | 864 | 583 | 1.5 | 30 | 81 | A |
| 36 | 13.3 | 1.2 | 0.7 | 0.3 | 48.9 | 4.4 | 2.5 | 19.9 | 1.8 | 11 | 1064 | 827 | 1.3 | 34.6 | 76 | B |
| 37 | 8.9 | 1.1 | 0.6 | 0.3 | 25.7 | 3.1 | 1.9 | 13.8 | 1.7 | 8.2 | 935 | 834 | 1.1 | 57.5 | 73 | — |
| 38 | 13.7 | 1.3 | 0.6 | 0.5 | 29.4 | 2.8 | 1.4 | 21.7 | 2.1 | 10.5 | 978 | 382 | 2.6 | 57.2 | 66 | — |

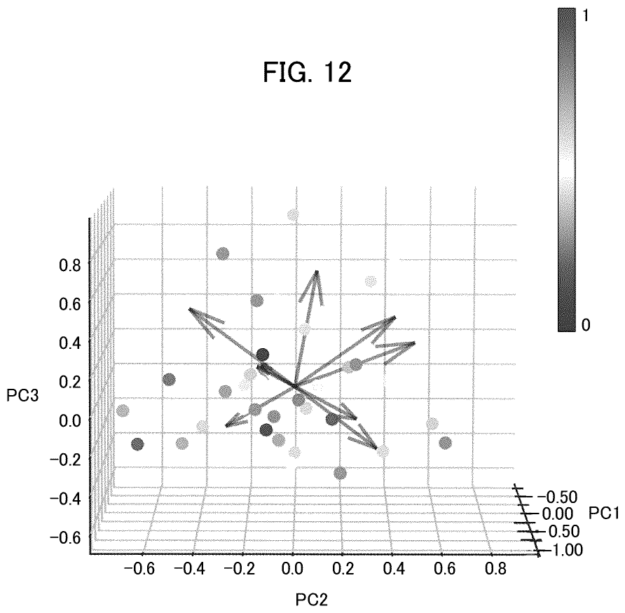

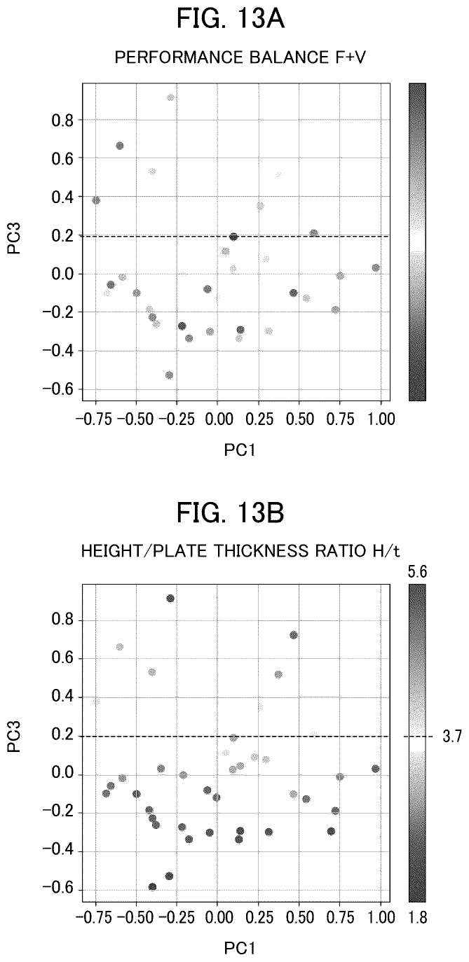

FIG. 12 illustrates a principal component plot where principal component scores obtained from the result of principal component analysis are plotted. From the result in FIG. 12, the H/t ratio is extracted as a design factor that affects a value obtained by adding the spring load F and the volume percentage V, which is a performance balance of the electrical contact spring. FIG. 13A illustrates principal component scores of values obtained by adding the spring load F and the volume percentage V. FIG. 13B illustrates the H/t ratio corresponding to values obtained by adding the spring load F and the volume percentage V in FIG. 13A. It is evident from FIG. 13A that principal component scores with PC3 in the range of −0.6 to 0.2 are good for the performance balance of the electrical contact spring. It is evident from FIG. 13B that an H/t ratio where the performance balance of the electrical contact spring is good is from 1.8 to 3.7.

Thus, from the result of the principal component analysis, it is evident that the electrical contact spring 1 including a metallic material that satisfies S/Y=1.2 to 2.5 can achieve both excellent spring load and excellent stress relaxation resistance when H/t is 1.8 or more and 3.7 or less.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An electrical contact spring comprising;
a metallic material, wherein
S/Y is 1.2 or more and 2.5 or less when a vicinity of a boundary between an elastic region and a plastic region in a true stress−true strain curve of the metallic material is approximated using the Voce equation expressed in equation 1
$$σ = S - ( S - Y ) {exp}^{- c ε} \qquad [ Equation 1 ]$$
where S is a maximum value of true stress σ of the metallic material, Y is elastic limit stress of the metallic material, and c is a constant related to logarithmic plastic strain ε of the metallic material.

2. The electrical contact spring according to claim 1, wherein
the electrical contact spring comprises a long plate material that has a convex part at a center part of the long plate material in a longitudinal direction, the convex part being more convex than both end parts of the long plate material, and
a height from the both end parts of the long plate material to the convex part relative to a thickness of the long plate material is 1.8 or more and 3.7 or less.
